(19) United States
(12) Patent Application Publication
(10) Pub. No.: US 2009/0095785 A1
(43) Pub. Date: Apr. 16, 2009

(54) Magnetic tool belt and tool belt accessories

(75) Inventor: Andre A. Woolery, Menlo Park, CA (US)

Correspondence Address: Jonathan O. Owens;HAVERSTOCK & OWENS LLP, 162 North Wolfe Road, Sunnyvale, CA, 94086, US

(73) Assignee: AAW Products, Inc.

(21) Appl. No.: 12/287,287

(22) Filed: Oct. 7, 2008

Related U.S. Application Data
(60) Provisional application No. 60/998,839, filed on Oct. 11, 2007.
(60) Provisional application No. 61/003,751, filed on Nov. 19, 2007.
(60) Provisional application No. 61/004,440, filed on Nov. 26, 2007.

(51) Int. Cl. A45F 5/00; A41F 9/00; B25H 3/00

(52) U.S. Cl. 224/665; 2/311; 2/338; 224/183; 224/680; 29/469

(57) ABSTRACT

Magnetic tool belts and tool belt accessories for holding work items comprise a body having a surface and one or more magnets coupled to the surface for holding work items. The one or more magnets providing a magnetic force for attracting magnetically attractable objects and securing them to the surface such that they are readily available for use. The body comprising a tool belt, tool pouch, hammer holder, belt clip or any other suitable tool belt accessory.

### RELATED APPLICATIONS

The Patent Application claims priority under 35 U.S.C. section 119(e) to the co-pending U.S. Provisional Patent Application Ser. No. 60/998,839, filed Oct. 11, 2007, and entitled “MAGNETIC TOOL HOLDERS,” to the co-pending U.S. Provisional Patent Application Ser. No. 61/003,751, filed Nov. 19, 2007, and entitled “MAGNETIC TOOL HOLDERS” and to the co-pending U.S. Provisional Patent Application Ser. No. 61/004,440, filed Nov. 26, 2007, and entitled “MAGNETIC TOOL HOLDERS,” all of which are hereby incorporated by reference.

### FIELD OF THE INVENTION

The present invention generally relates to magnetic tool holders. More particularly the present invention relates to a magnetic tool belt and tool belt accessories.

### BACKGROUND OF THE INVENTION

Professional users of small hand tools such as carpenters, seamstresses, auto mechanics, electricians, plumbers, construction workers, as well as non-professional do-it-yourselves are often frustrated whenever they misplace, drop or fumble tools or supplies while doing their jobs. Workers often times wear aprons or similar devices to hold these supplies to keep them close at hand and also to be able to move more freely. However, wearing an apron or similar device has certain limitations. For instance, repetitive reaching in pockets for supplies is tedious. Moreover, wearing an apron or similar device does not help the task of reaching for supplies while holding a perfectly aligned work piece or holding a heavy work piece with one hand and some other tool with the other. Additionally, aprons and similar devices are prone to accidentally spill the tools and work items that are held within the pockets of the apron or similar device. Often this spillage is caused because the worker accidentally knocked the tools or work items over with their hand or because of how the worker is positioned while doing their job. Other times the contents will spill whenever the worker removes the pouch from his waist and puts it down.

### SUMMARY OF THE INVENTION

Magnetic tool belts and tool belt accessories for holding work items comprise a body having a surface and one or more magnets coupled to the surface for holding work items. The one or more magnets providing a magnetic force for attracting magnetically attractable objects and securing them to the surface such that they are readily available for use. The body comprising a tool belt, tool pouch, hammer holder, belt clip or any other suitable tool belt accessory.

One aspect of the present application is directed to a belt that receives belt accessories. The belt comprises a body having a surface and one or more magnets coupled to the surface for holding work items. The body is an elongated strap having a first and second end, wherein the first and second ends are positioned substantially opposite each other. The belt further comprises, a first fastener coupled to the first end and a second fastener coupled to the second end, wherein the first fastener is configured to removably attach to the second fastener forming a loop. The first fastener and the second fastener are adjustable and thereby allow the circumference of the loop to vary. The second fastener and the first fastener comprise any combination of a hook-and-loop fastening system, a zipper, a button or a buckle.

In some embodiments, the one or more magnets are removably attached to the surface. In some embodiments, the surface comprises a plurality of layers for housing the one or more magnets wherein the one or more magnets are completely enclosed within the plurality of layers. In some embodiments, the one or more magnets are accessible from within the plurality of layers. In other embodiments, at least some portion of the one or more magnets is exposed. The shape of the one or more magnets is selected from a set comprising a strip, a ball bearing, and a disc. In some embodiments, the one or more magnets are positioned to avoid mutual magnetic attraction between each other. In some embodiments, at least one of the one or more magnets comprise a ceramic magnet and or a neodymium magnet.

The surface comprises any combination of leather, cotton, cotton/polyester blends, plastic, nylon, vinyl, neoprene, synthetic leather, rubber or other material. In some embodiments, the one or more magnets are distributed across the surface so as to allow metallic work items to be secured to substantially all points of the surface.

The belt further comprises one or more belt accessories, wherein the one or more belt accessories are removably attached to the surface of the belt wherein the one or more belt accessories comprise an accessory fastener for removably attaching the accessory to the belt, an accessory body having an accessory surface and one or more accessory magnets coupled to the accessory surface for holding work items. In some embodiments, the accessory body comprises a tool pouch. In other embodiments, the accessory body comprises a belt clip. In yet other embodiments, the accessory body comprises a hammer holder.

In some embodiments, the accessory surface comprises a plurality of accessory layers for housing the one or more accessory magnets wherein the one or more accessory magnets are completely enclosed within the plurality of accessory layers. Alternatively, the one or more accessory magnets are accessible from within the plurality of accessory layers. In some embodiments, at least some portion of the one or more accessory magnets is exposed. In some embodiments, the one or more magnets and one or more accessory magnets are interchangeable. In some embodiments, the accessory body of the one or more belt accessories comprise any combination of a tool pouch, a belt clip, or a hammer holder.

Another aspect of the present application is directed to a belt accessory. The belt accessory comprises a body having a surface, one or more magnets coupled to the surface for holding work items and a fastener for removably attaching the belt accessory to a belt. In some embodiments, the body comprises a tool pouch. In other embodiments, the body comprises a belt clip. In yet other embodiments, the body comprises a hammer holder. The fastener comprises any combination of a belt loop, hook-and-loop fastening system, a zipper, a button, or a buckle. In some embodiments, the one or more magnets are removably attached to the surface. In some embodiments, the surface comprises a plurality of layers for housing the one or more magnets wherein the one or more magnets are completely enclosed within the plurality of layers. Alternatively, the one or more magnets are accessible from within the plurality of layers. In some embodiments, at least some portion of the one or more magnets is exposed. The shape of the one or more magnets is selected from a set comprising a strip, a ball bearing, and a disc. In some embodiments, the one or more magnets are positioned to avoid mutual magnetic attraction between each other. In some embodiments, at least one of the one or more magnets comprise a ceramic magnet and or a neodymium magnet.

The surface comprises any combination of leather, cotton, cotton/polyester blends, plastic, nylon, vinyl, neoprene, synthetic leather, rubber or other material. In some embodiments, the one or more magnets are distributed across the surface so as to allow metallic work items to be secured to substantially all points of the surface. In some embodiments, the body comprises any combination of a tool pouch, a belt clip, or a hammer holder.

Another aspect of the present application is direct to a belt for receiving accessories. The belt comprises a body having a surface, one or more magnets coupled to the surface for holding work items and one or more belt accessories comprising a body having an accessory surface, one or more accessory magnets coupled to the accessory surface for holding work items and at least one fastener for removably attaching the one or more belt accessories to the belt.

Yet another aspect of the present application is directed to a method of manufacturing a belt and belt accessories. The method comprises constructing a belt body having a surface, coupling one or more magnets to the surface for holding work items. The method further comprises constructing an accessory body having an accessory surface, coupling one or more accessory magnets to the accessory surface for holding work items and coupling the accessory body to the surface of the belt body.

### BRIEF DESCRIPTION OF THE DRAWINGS

FIG. 1A illustrates a front view of one embodiment of the present application comprising a tool belt with removably attachable accessories.

FIG. 1B illustrates a front view of another embodiment of the present application comprising a tool belt with removably attachable accessories.

FIG. 2A illustrates a front view of an embodiment of the present application comprising a tool belt accessory wherein the body is a hammer holder. FIG. 2B illustrates an angled view of an embodiment of the present application comprising a tool belt accessory wherein the body is a hammer holder.

FIG. 3A illustrates a front view of an embodiment of the present application comprising a tool belt accessory wherein the body is a belt clip.

FIG. 3B illustrates a back view of an embodiment of the present application comprising a tool belt accessory wherein the body is a belt clip.

FIG. 3C illustrates a side view of an embodiment of the present application comprising a tool belt accessory wherein the body is a belt clip.

FIG. 4A illustrates a front view of an embodiment of the present application comprising a tool belt accessory wherein the body is a tool pouch.

FIG. 4B illustrates a side view of an embodiment of the present application comprising a tool belt accessory wherein the body is a tool pouch.

FIG. 5 illustrates a flow chart of an embodiment of a method of manufacturing the belt and belt accessories of the present application

### DETAILED DESCRIPTION OF THE INVENTION

In the following description, numerous details are set forth for purpose of explanation. However, one of ordinary skill in the art will realize that the invention may be practiced without the use of these specific details.

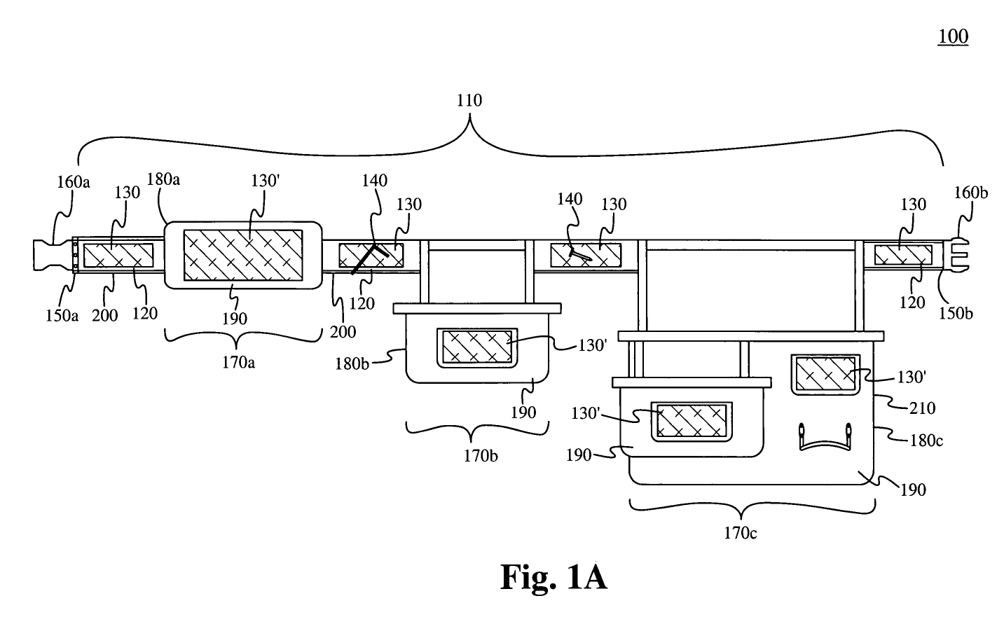

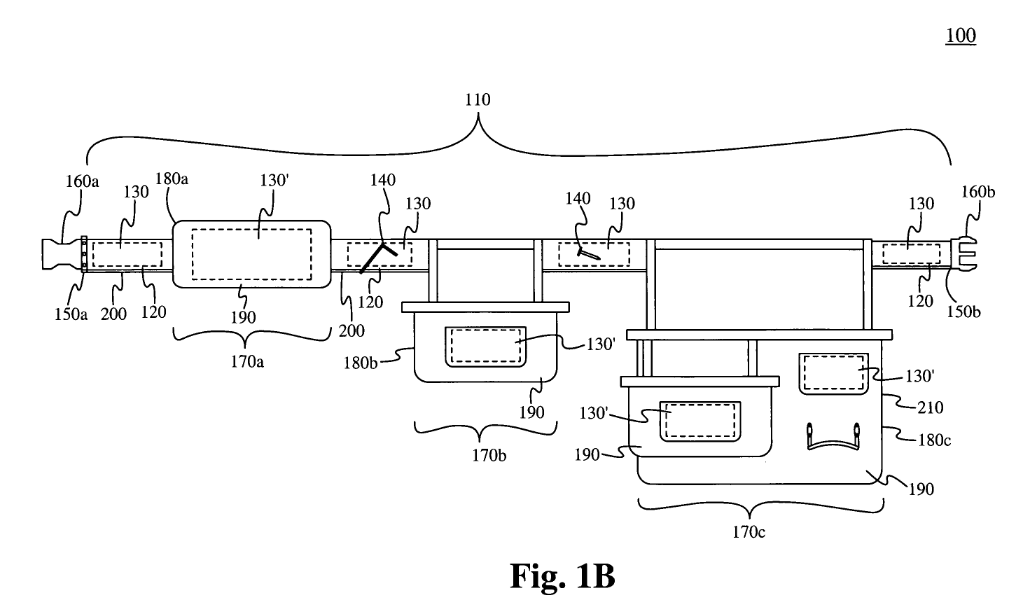

Referring to FIGS. 1A and 1B, a first embodiment of the magnetic tool belt 100 is depicted therein. Specifically, the magnetic tool belt 100 shown comprises a body 110 with a surface 120, one or more magnets 130 coupled to the surface 120 for magnetically holding work items 140 and one or more belt accessories 170a, 170b, 170c removably attached to the surface 120. Alternatively, any number of accessories are able to be removably attached to the surface 120 of the belt 100. The body 110 comprises an elongated strap having a first and second end 150a, 150b, wherein the first and second ends 150a, 150b are positioned substantially opposite each other. It is noted that the precise structure of the body 110 can take many forms which are each compatible with the present device and well known in the art. A first fastener 160a is coupled to the first end 150a and a second fastener 160b is coupled to the second end 150b wherein the first and second fasteners 160a, 160b are able to removably attach to each other forming a loop. The first and second fasteners 160a, 160b are also adjustable such that the circumference of the loop is allowed to be varied by adjusting the first and second fasteners 160a, 160b. In some embodiments, the first and second fasteners 160a, 160b comprise any combination of a hook-and-loop fastening system, a zipper, a button, or a buckle. In other embodiments, the first and second fasteners 160a, 160b comprise any other fastening means. The surface 120 comprises various types and combinations of materials including, but not limited to leather, cotton, cotton/polyester blends, plastic, nylon, vinyl, neoprene, synthetic leather, knit or rubber. In some embodiments, the surface 120 further comprises a plurality of layers 200.

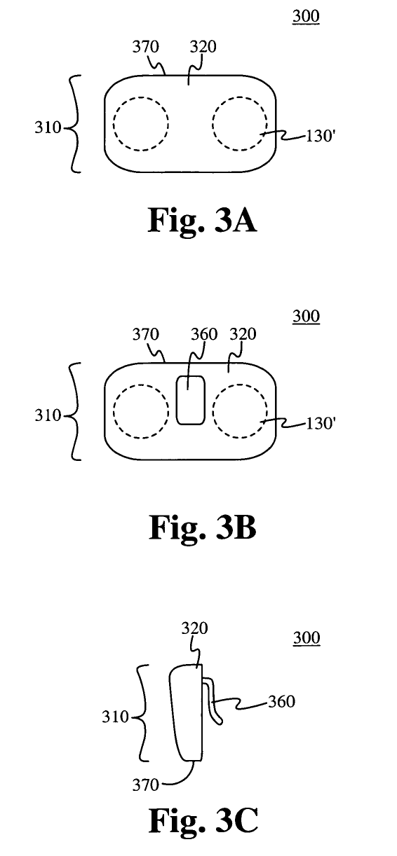

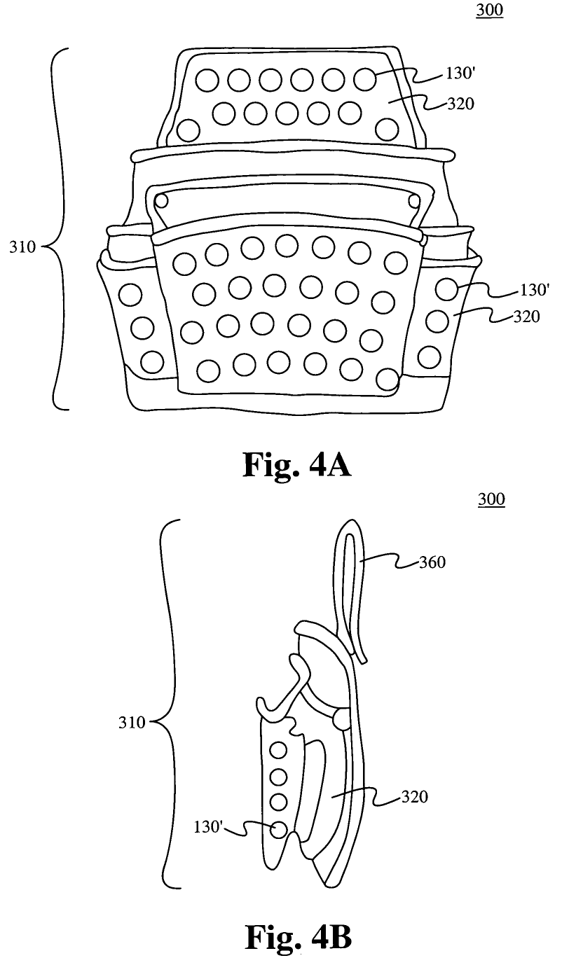

The magnets 130 are neodymium magnets, however in some embodiments, the magnets 130 are ceramic or any other type or combination of magnets. Neodymium has been chosen because it is one of the strongest permanent magnets made and does not lose its strength over time. Typically, as shown in FIG. 1A, a portion of the magnets 130 is exposed outside of the surface 120. Alternatively, as shown in FIG. 1B, the layers 200 of the surface 120 completely enclose and house the magnets 130. In some embodiments, the magnets 130 are accessible from the surface 120. Where the magnets 130 are accessible from the surface 120, various means can be utilized to selectively seal them into the surface 120 to prevent them from falling out of place. These means include, but are not limited to buttons, buckles, snaps, hooks, threads or zippers. Additionally, as shown in FIGS. 1A and 1B, the magnets 130 are strips. Alternatively, as shown in FIGS. 3A, 3B, 4A and 4B, the magnets 130′ are discs or small balls respectively. In some embodiments, the magnets 130 comprise any combination of strips, discs or small balls.

As further shown in FIGS. 1A and 1B, the magnets 130 are substantially permanently coupled onto the surface 120. Alternatively, the magnets 130 are removably attached to the surface 120. Where the magnets 130 are removably attached to the surface 120, various means are able to be utilized to removably attach them to the surface 120. These means include, but are not limited to buttons, buckles, snaps, hooks, threads or zippers. In some embodiments, the magnets 130 are positioned along the surface 120 such that mutual magnetic attraction between each other is avoided. As shown in FIGS. 1A and 1B, the magnets 130 are sufficiently numerous and distributed across the surface 120 so as to allow metallic work items 140 to be secured to substantially all points of the surface 120.

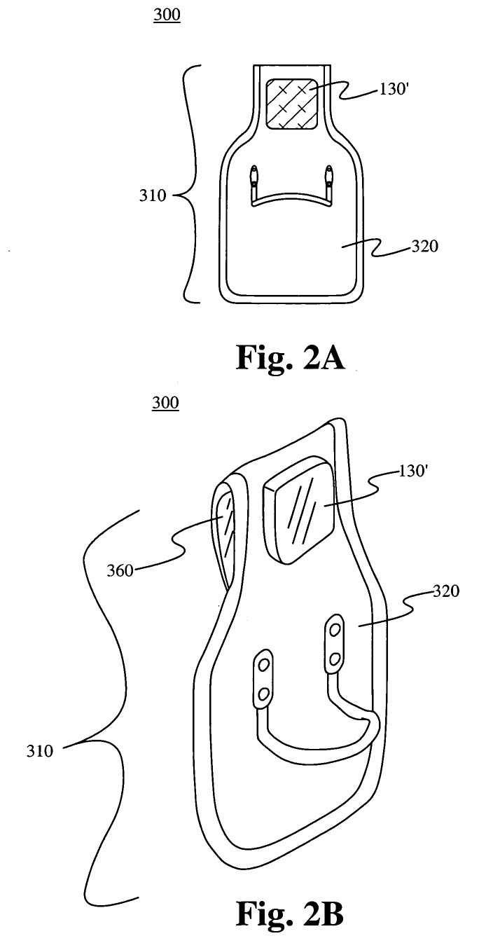

Each of the belt accessories 170a, 170b, 170c comprise an accessory fastener 360 (as shown in FIGS. 2B, 3B, 3C and 4B) that removably attaches the accessories 170a, 170b, 170c to the belt 100, an accessory body 180a, 180b, 180c having an accessory surface 190, and one or more accessory magnets 130′ coupled to the accessory surface 190 for holding work items 140. As shown in FIGS. 1A and 1B, the accessory bodies 180a, 180b, 180c comprise a belt clip 180a, a tool pouch 180b and a combination of a tool pouch and a hammer holder 180c. Alternatively, the accessory bodies 180a, 180b, 180c could be any belt accessory body including, but not limited to a tool pouch, a belt clip, a hammer holder and any combination thereof. Further, any number of belt accessories 170a, 170b, 170c and corresponding belt accessory bodies 180a, 180b, 180c can be utilized so long as the belt surface 120 has sufficient space to removably attach to them. The accessory fastener 360 (as shown in FIGS. 2B, 3B, 3C and 4B) comprises any combination of a belt loop, a hook-and-loop fastening system, a zipper, a button, or a buckle. Alternatively, the accessory fastener 360 comprises any other fastening means.

The accessory surface 190 comprises various types and combinations of materials including, but not limited to leather, cotton, cotton/polyester blends, plastic, nylon, vinyl, neoprene, synthetic leather, knit or rubber. In some embodiments, the accessory surface 190 further comprises a plurality of accessory layers 210.

The accessory magnets 130′ are neodymium magnets, however in some embodiments, the accessory magnets 130′ are ceramic or any other type or combination of magnets. Neodymium has been chosen because it is one of the strongest permanent magnets made and does not lose its strength over time. Typically, as shown in FIG. 1A, a portion of the accessory magnet 130′ is exposed outside of the accessory surface 190. Alternatively, as shown in FIG. 1B, the accessory layers 210 of the accessory surface 190 completely enclose and house the accessory magnets 130′. In some embodiments, the accessory magnets 130′ are accessible from the accessory surface 190. Where the accessory magnets 130′ are accessible from the accessory surface 190, various means are able to be utilized to selectively seal them into the accessory surface 190 to prevent them from falling out of place. These means include, but are not limited to buttons, buckles, snaps, hooks, threads or zippers. Additionally, as shown in FIGS. 1A and 1B, the accessory magnets 130′ are strips. Alternatively, as shown in FIGS. 3A, 3B, 4A and 4B, the accessory magnets 130′ are discs or small balls respectively. In some embodiments, the accessory magnets 130′ comprise any combination of strips, discs or small balls.

As further shown in FIGS. 1A and 1B, the accessory magnets 130′ are substantially permanently coupled onto the accessory surface 190. Alternatively, the accessory magnets 130′ are removably attached to the accessory surface 190. Where the accessory magnets 130′ are removably attached to the accessory surface 190, various means are able to be utilized to removably attach them to the accessory surface 190. These means include, but are not limited to buttons, buckles, snaps, hooks, threads or zippers. In some embodiments, the accessory magnets 130′ are positioned along the accessory surface 190 such that mutual magnetic attraction between each other is avoided. In some embodiments, the accessory magnets 130′ are sufficiently numerous and distributed across the accessory surface 190 so as to allow metallic work item 140 to be secured to substantially all points of the accessory surface 190. Additionally, in some embodiments, the magnets 130 and accessory magnets 130′ are interchangeable.

In operation, this design of the magnetic tool belt 100 allows a worker wearing the belt 100 to securely hold metallic work items 140 in readily accessible locations along the tool belt body 110 and the tool belt accessory bodies 180a, 180b, 180c via the magnetic attraction of the magnets 130 and the accessory magnets 130′. By doing so, the magnetic tool belt has the advantage of preventing the spilling of metallic work items 140 as well as making them more convenient to use by ensuring secure and convenient placement capabilities.

FIGS. 2A, 2B, 3A, 3B, 3C, 4A and 4B show another aspect of the present application directed to a belt accessory 300. The embodiments shown in FIGS. 2A, 2B, 3A, 3B, 3C, 4A and 4B are substantially the same as the belt accessories 170a, 170b, 170c discussed above except for the differences described herein. As shown in FIGS. 2A and 2B, the belt accessory 300 comprises a body 310 having a surface 320 and one or more magnets 130′ coupled to the surface 320 for holding work items 140 (not shown). In some embodiments, the belt accessory 300 further comprises a fastener 360 for removably attaching the belt accessory 300 to a belt (not shown). As shown in FIGS. 2A and 2B, the body 310 comprises a hammer holder. In other embodiments, as shown in FIGS. 3A,3B and 3C, the body 310 comprises a belt clip. In yet other embodiments, as shown in FIGS. 4A and 4B, the body 310 comprises a tool pouch. Alternatively, the body 310 is able to be any belt accessory body or combination thereof including, but not limited to a tool pouch, a belt clip, and a hammer holder. It is noted that the precise structure of the body 310 can take many forms which are each compatible with the present application and well known in the art.

The fastener 360 comprises any combination of a belt loop, a hook-and-loop fastening system, a zipper, a button, or a buckle. Alternatively, the fastener 360 comprises any other fastening means. The surface 320 comprises various types and combinations of materials including, but not limited to leather, cotton, cotton/polyester blends, plastic, nylon, vinyl, neoprene, synthetic leather, knit or rubber. In some embodiments, the surface 320 further comprises a plurality of layers 370 as shown in FIGS. 3A, 3B and 3C.

The magnets 130′ are neodymium magnets, however in some embodiments, the magnets 130′ are ceramic or any other type or combination of magnets. Neodymium has been chosen because it is one of the strongest permanent magnets made and does not lose its strength over time. Typically, as shown in FIGS. 2A and 2B, a portion of the magnets 130′ is exposed outside of the surface 320. Alternatively, as shown in FIGS. 3A and 3B, the accessory layers 370 of the surface 320 completely enclose and house the magnets 130′. In some embodiments, the magnets 130′ are accessible from the surface 320. Where the magnets 130′ are accessible from the surface 320, various means can be utilized to selectively seal them into the surface 320 to prevent them from falling out of place. These means include, but are not limited to buttons, buckles, snaps, hooks, threads or zippers. Additionally, as shown in FIGS. 2A and 2B, the magnets 130′ are strips. Alternatively, as shown in FIGS. 3A, 3B, 4A and 4B, the magnets 130′ are discs or small balls respectively. In some embodiments, the magnets 130′ comprise any combination of strips, discs or small balls.

The magnets 130′ are substantially permanently coupled onto the surface 320. Alternatively, the magnets 130′ are removably attached to the surface 320. Where the magnets 130′ are removably attached to the surface 320, various means can be utilized to removably attach them to the surface 320. These means include, but are not limited to buttons, buckles, snaps, hooks, threads or zippers. In some embodiments, the magnets 130′ are positioned along the surface 320 such that mutual magnetic attraction between each other is avoided. In some embodiments, as shown in FIGS. 4A and 4B, the magnets 130′ are sufficiently numerous and distributed across the surface 320 so as to allow metallic work items (not shown) to be secured to substantially all points of the surface 320.

In operation, this design of the magnetic belt accessory 300 allows a worker wearing the accessory 300 to securely hold metallic work items in readily accessible locations along the belt accessory body 310 via the magnetic attraction of the magnets 130′. By doing so, the magnetic belt accessory 300 of the present application has the advantage of preventing the spilling of metallic work items as well as making them more convenient to use by ensuring secure and convenient placement capabilities.

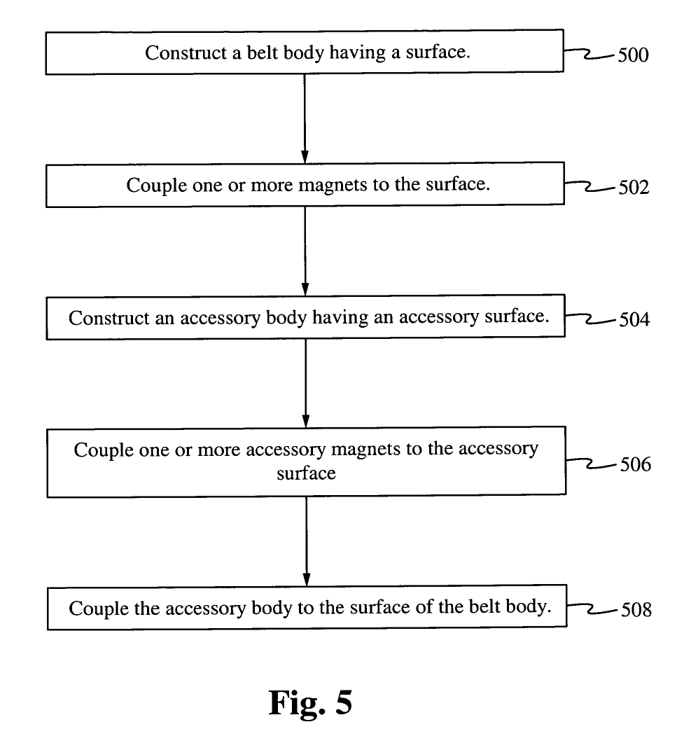

Another aspect of the present application is directed to a method of manufacturing the tool belt and tool belt accessories. This method will now be discussed in conjunction with the flow chart illustrated in FIG. 5. In particular, a belt body having a surface is constructed at the step 500. One or more magnets are then coupled to the surface at the step 502. At the step 504, an accessory body is constructed having an accessory surface. In some embodiments, the accessory body comprises a tool pouch. In other embodiments, the accessory body comprises a hammer holder. In yet other embodiments, the accessory body comprises a belt clip. Further, in some embodiments, the one or more magnets and accessory magnets are removably attached to the surface. One or more accessory magnets are then coupled to the accessory surface at the step 506. At the step 508, the accessory body is coupled to the surface of the belt body.

The magnetic tool belt and belt accessories described herein comprise a body having a surface and one or more magnets coupled to the surface for holding work items. By incorporating these magnets with the body of the tool belt and tool belt accessories the present device allows a worker wearing or using the tool belt or tool belt accessories to securely hold metallic tools and other items in readily accessible locations along the body via the magnetic attraction of the magnets. Thus, the worker is able to work more efficiently as they are less likely to fumble or drop tools and other items thereby increasing work production. Further, the present device allows for more flexibility in the worker's body position while working because the magnets prevent tools from falling when tilted, even if tilted completely upside down. Accordingly, the magnetic tool belt and belt accessories described herein have numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the body of the tool belt and belt accessories of the present invention can be any type of belt or belt accessory body. Further, it is apparent to one of ordinary skill in the art that the precise structure of these bodies can be substantially varied while still being compatible with the present invention. Accordingly, the device of the present invention can be implemented in several different ways and have several different appearances.

What is claimed is:

1. A belt for receiving belt accessories comprising:
a. a body having a surface; and
b. one or more magnets coupled to the surface for holding work items.

2. The belt as claimed in claim 1, wherein the body is an elongated strap having a first and second end, wherein the first and second ends are positioned substantially opposite each other.

3. The belt as claimed in claim 2, further comprising a first fastener coupled to the first end and a second fastener coupled to the second end, wherein the first fastener is configured to removably attach to the second fastener forming a loop.

4. The belt as claimed in claim 3, wherein the first fastener and the second fastener are adjustable and thereby allow the circumference of the loop to vary.

5. The belt as claimed in claim 4, wherein the second fastener and the first fastener comprise any combination of a hook-and-loop fastening system, a zipper, a button or a buckle.

6. The belt as claimed in claim 1, wherein the one or more magnets are removably attached to the surface.

7. The belt as claimed in claim 1, wherein the surface comprises a plurality of layers for housing the one or more magnets.

8. The belt as claimed in claim 7, wherein the one or more magnets are completely enclosed within the plurality of layers.

9. The belt as claimed in claim 8, wherein the one or more magnets are accessible from within the plurality of layers.

10. The belt as claimed in claim 1, wherein the at least some portion of the one or more magnets is exposed.

11. The belt as claimed in claim 1, wherein a shape of the one or more magnets is selected from a set comprising a strip, a ball bearing, and a disc.

12. The belt as claimed in claim 1, wherein the one or more magnets are positioned to avoid mutual magnetic attraction between each other.

13. The belt as claimed in claim 1, wherein the at least one of the one or more magnets comprise a ceramic magnet.

14. The belt as claimed in claim 1, wherein at least one of the one or more magnets comprise a neodymium magnet.

15. The belt as claimed in claim 1, wherein the surface comprises any combination of leather, cotton, cotton/polyester blends, plastic, nylon, vinyl, neoprene, synthetic leather, rubber or other material.

16. The belt as claimed in claim 1, wherein the one or more magnets are distributed across the surface so as to allow metallic work items to be secured to substantially all points of the surface.

17. The belt as claimed in claim 1, further comprising one or more belt accessories, wherein the one or more belt accessories are removably attached to the surface of the belt.

18. The belt as claimed in claim 17, wherein the one or more belt accessories comprise:
a. an accessory fastener for removably attaching the accessory to the belt;
b. an accessory body having an accessory surface; and
c. one or more accessory magnets coupled to the accessory surface for holding work items.

19. The belt as claimed in claim 18, wherein the accessory body comprises a tool pouch.

20. The belt as claimed in claim 18, wherein the accessory body comprises a belt clip.

21. The belt as claimed in claim 18, wherein the accessory body comprises a hammer holder.

22. The belt as claimed in claim 18, wherein the accessory surface comprises a plurality of accessory layers for housing the one or more accessory magnets.

23. The belt as claimed in claim 22, wherein the one or more accessory magnets are completely enclosed within the plurality of accessory layers.

24. The belt as claimed in claim 23, wherein the one or more accessory magnets are accessible from within the plurality of accessory layers.

25. The belt as claimed in claim 18, wherein the at least some portion of the one or more accessory magnets is exposed.

26. The belt as claimed in claim 18, wherein the one or more magnets and one or more accessory magnets are interchangeable.

27. The belt as claimed in claim 18, wherein the accessory body of the one or more belt accessories comprise any combination of a tool pouch, a belt clip or a hammer holder.

28. A belt accessory comprising:
a. a body having a surface;
b. one or more magnets coupled to the surface for holding work items; and
c. a fastener for removably attaching the belt accessory to a belt.

29. The belt accessory as claimed in claim 28, wherein the body comprises a tool pouch.

30. The belt accessory as claimed in claim 28, wherein the body comprises a belt clip.

31. The belt accessory as claimed in claim 28, wherein the body comprises a hammer holder.

32. The belt accessory as claimed in claim 28, wherein the fastener comprises any combination of a belt loop, hook-and-loop fastening system, a zipper, a button, or a buckle.

33. The belt accessory as claimed in claim 28, wherein the one or more magnets are removably attached to the surface.

34. The belt accessory as claimed in claim 28, wherein the surface comprises a plurality of layers for housing the one or more magnets.

35. The belt accessory as claimed in claim 34, wherein the one or more magnets are completely enclosed within the plurality of layers.

36. The belt accessory as claimed in claim 35, wherein the one or more magnets are accessible from within the plurality of layers.

37. The belt accessory as claimed in claim 28, wherein the at least some portion of the one or more magnets is exposed.

38. The belt accessory as claimed in claim 28, wherein a shape of the one or more magnets is selected from a set comprising a strip, a ball bearing, and a disc.

39. The belt accessory as claimed in claim 28, wherein the one or more magnets are positioned to avoid mutual magnetic attraction between each other.

40. The belt accessory as claimed in claim 28, wherein the at least one of the one or more magnets comprise a ceramic magnet.

41. The belt accessory as claimed in claim 28, wherein at least one of the one or more magnets comprise a neodymium magnet.

42. The belt accessory as claimed in claim 28, wherein the surface comprises any combination of leather, cotton, cotton/polyester blends, plastic, nylon, vinyl, neoprene, synthetic leather, rubber or other material.

43. The belt accessory as claimed in claim 28, wherein the one or more magnets are distributed across the surface so as to allow magnetic work items to be secured to substantially all points of the surface.

44. The belt accessory as claimed in claim 28, wherein the body comprises any combination of a tool pouch, a belt clip, or a hammer holder.

45. A belt for receiving belt accessories comprising:
a. a body having a surface;
b. one or more magnets coupled to the surface for holding work items; and
c. one or more belt accessories comprising:
i. a body having an accessory surface;
ii. one or more accessory magnets coupled to the accessory surface for holding work items; and
iii. at least one fastener for removably attaching the one or more belt accessories to the belt.

46. A method of manufacturing a belt and belt accessories comprising:
a. constructing a belt body having a surface;
b. coupling one or more magnets to the surface for holding work items;
c. constructing an accessory body having an accessory surface;
d. coupling one or more accessory magnets to the accessory surface for holding work items; and
e. coupling the accessory body to the surface of the belt body.
